(19) United States
(12) Patent Application Publication
(10) Pub. No.: US 2024/0053308 A1
(43) Pub. Date: Feb. 15, 2024

(54) Peak Alignment Method for Gas Chromatography Flow Splitter

(71) Applicant: LECO Corporation, St. Joseph, MI (US)

(72) Inventor: Mark Firmer Merrick, Bridgman, MI (US)

(73) Assignee: LECO Corporation, St. Joseph, MI (US)

(21) Appl. No.: 18/348,624

(22) Filed: Jul. 7, 2023

Related U.S. Application Data
(60) Provisional application No. 63/371,139, filed on Aug. 11, 2022.

(51) Int. Cl. G01N 30/86; G01N 30/10; G01N 30/78

(52) U.S. Cl. CPC G01N 30/8631; G01N 30/10; G01N 30/78; G01N 30/8665; G01N 2030/025

(57) ABSTRACT

A method includes receiving respective first and second sets of detection data generated by first and second detectors of a gas chromatograph (GC) during a session and representative of chromatographic properties of first and second portions of an effluent delivered to the first and second detectors from first and second transfer lines of the GC. The method also includes receiving a temperature profile that identifies first and second temperature zones of the first and second portions of the effluent during the session. The second set of detection data is misaligned relative to the first set along a time axis. The method also includes applying an alignment profile to the second set to align the first and second sets along the time axis. The alignment profile is based on the temperature profile.

### CROSS REFERENCE TO RELATED APPLICATIONS

This application claims priority under 35 U.S.C. § 119(e) to U.S. Provisional Application 63/371,139, filed on Aug. 11, 2022. The disclosure of this prior application is considered part of the disclosure of this application and is hereby incorporated by reference in its entirety.

### TECHNICAL FIELD

This disclosure relates to flow splitters for gas chromatography systems.

### BACKGROUND

Gas chromatography (GC) is conventionally used to separate and analyze compounds (e.g., volatile organic compounds (VOCs)) in a variety of applications and across a number of disciplines. Traditional gas chromatography may involve the combination of a sample, or mixture of analytes, to be analyzed with a carrier gas (e.g., helium or hydrogen) within a column to form an effluent. As the effluent moves through the column, various analytes may be separated from one another due to a variety of factors, such as, for example, flow characteristics, mass of the analyte, etc. Upon exiting the column, the signal of the separated analytes may be detected and recorded.

Flow splitters may be used to separate a single gas chromatographic flow into multiple portions, each to be analyzed by a respective detector. Typically, peak retention times of the signals from the respective detectors are not the same because the void times of transfer lines between the flow splitter and the detectors are different. To link the same chromatographic peak detected at the detectors, the retention times of the peaks must be aligned.

This section provides background information related to the present disclosure which is not necessarily prior art.

### SUMMARY

One aspect of the disclosure provides a computer-implemented method executed by data processing hardware that causes the data processing hardware to perform operations. The operations include receiving a first set of detection data. The first set of detection data is generated by a first detector of a gas chromatograph (GC) during a detection session and is representative of chromatographic properties of a first portion of an effluent delivered to the first detector from a first transfer line of the GC during the detection session. The operations include receiving a second set of detection data. The second set of detection data is generated by a second detector of the GC during the detection session and is representative of chromatographic properties of a second portion of the effluent delivered to the second detector from a second transfer line of the GC during the detection session. The second set of detection data is misaligned relative to the first set of detection data along a time axis. The operations include receiving a temperature profile for the detection session. The temperature profile identifies (i) a first temperature zone of the first portion of the effluent during the detection session, and (ii) a second temperature zone of the second portion of the effluent during the detection session. The operations include applying an alignment profile to the second set of detection data to align the first set of detection data and the second set of detection data along the time axis. The alignment profile is based on the temperature profile for the detection session.

Implementations of the disclosure may include one or more of the following features. In some examples, the first temperature zone includes a first temperature of the first portion of the effluent along the first transfer line. In those examples, the second temperature zone includes a second temperature of the second portion of the effluent along the second transfer line.

In some implementations, the alignment profile is further based on a flow condition profile. The flow condition profile identifies (i) a first set of flow conditions of the first portion of the effluent during the detection session, and (ii) a second set of flow conditions of the second portion of the effluent during the detection session. In further implementations, the first set of flow conditions includes (i) a length of the first transfer line, (ii) a diameter of the first transfer line, and (iii) an average flow velocity of the first portion of the effluent through the first transfer line during the detection session. In those further implementations, the second set of flow conditions includes (i) a length of the second transfer line, (ii) a diameter of the second transfer line, and (iii) an average flow velocity of the second portion of the effluent through the transfer line during the detection session. In some further implementations, the first set of flow conditions and the second set of flow conditions are the same during the detection session. Optionally, the first temperature zone and the second temperature zone are not the same during the detection session.

In some examples, the first transfer line receives the first portion of the effluent from a flow splitter of the GC, the second transfer line receives the second portion of the effluent from the flow splitter, and the flow splitter receives the effluent from an outlet end of a chromatographic column. In further examples, the GC includes a single-dimensional GC having a single chromatographic column. In those further examples, the flow splitter receives the effluent from the outlet end of the single chromatographic column. In other further examples, the GC includes a multi-dimensional GC having a plurality of chromatographic columns. In those further examples, the flow splitter receives the effluent from the outlet end of a last chromatographic column of the plurality of chromatographic columns.

Optionally, the operations further include generating the alignment profile based on calibration data obtained by the first detector and the second detector during a calibration session. The calibration data is representative of chromatographic properties of a calibration effluent different from the effluent of the detection session.

In some implementations, the operations further include determining that the second set of detection data is misaligned relative to the first set of detection data along the time axis. In those implementations, applying the alignment profile is in response to determining that the second set of detection data is misaligned relative to the first set of detection data along the time axis. In further implementations, the first set of detection data includes at least one peak corresponding to a compound present in the effluent, and the second set of detection data includes at least one peak corresponding to the compound present in the effluent. In those further implementations, determining that the second set of detection data is misaligned relative to the first set of detection data includes determining that the at least one peak of the second set of detection data is misaligned relative to the at least one peak of the first set of detection data along the time axis.

Another aspect of the disclosure provides a system including a gas chromatograph (GC). The GC includes (i) a chromatographic column having an outlet end, (ii) a first detector, (iii) a second detector, (iv) a first transfer line configured to deliver a first portion of an effluent to the first detector from the outlet end of the chromatographic column, (v) a second transfer line configured to deliver a second portion of the effluent to the second detector from the outlet end of the chromatographic column, and (vi) a controller performing operations. The operations include receiving a first set of detection data. The first set of detection data is generated by the first detector during a detection session and is representative of chromatographic properties of the first portion of the effluent. The operations include receiving a second set of detection data. The second set of detection data is generated by the second detector during the detection session and is representative of chromatographic properties of the second portion of the effluent. The second set of detection data is misaligned relative to the first set of detection data along a time axis. The operations include receiving a temperature profile for the detection session. The temperature profile identifies (i) a first temperature zone of the first portion of the effluent during the detection session, and (ii) a second temperature zone of the second portion of the effluent during the detection session. The operations include applying an alignment profile to the second set of detection data to align the first set of detection data and the second set of detection data along the time axis. The alignment profile is based on the temperature profile for the detection session.

Implementations of the disclosure may include one or more of the following features. In some examples, the first temperature zone includes a first temperature of the first portion of the effluent along the first transfer line. In those examples, the second temperature zone includes a second temperature of the second portion of the effluent along the second transfer line.

In some implementations, the alignment profile is further based on a flow condition profile. The flow condition profile identifies (i) a first set of flow conditions of the first portion of the effluent during the detection session, and (ii) a second set of flow conditions of the second portion of the effluent during the detection session. In further implementations, the first set of flow conditions includes (i) a length of the first transfer line, (ii) a diameter of the first transfer line, and (iii) an average flow velocity of the first portion of the effluent through the first transfer line during the detection session. In those further implementations, the second set of flow conditions includes (i) a length of the second transfer line, (ii) a diameter of the second transfer line, and (iii) an average flow velocity of the second portion of the effluent through the second transfer line during the detection session. In some further implementations, the first set of flow conditions and the second set of flow conditions are the same during the detection session. Optionally, the first temperature zone and the second temperature zone are not the same during the detection session.

In some examples, the first transfer line receives the first portion of the effluent from a flow splitter of the GC, the second transfer line receives the second portion of the effluent from the flow splitter, and the flow splitter receives the effluent from the outlet end of the chromatographic column. In further examples, the GC includes a single-dimensional GC having a single chromatographic column. In those further examples, the flow splitter receives the effluent from the outlet end of the single chromatographic column. In other further examples, the GC includes a multi-dimensional GC having a plurality of chromatographic columns. In those further examples, the flow splitter receives the effluent from the outlet end of a last chromatographic column of the plurality of chromatographic columns.

Optionally, the operations further include generating the alignment profile based on calibration data obtained by the first detector and the second detector during a calibration session. The calibration data is representative of chromatographic properties of a calibration effluent different from the effluent of the detection session.

In some implementations, the operations further include determining that the second set of detection data is misaligned relative to the first set of detection data along the time axis. In those implementations, applying the alignment profile is in response to determining that the second set of detection data is misaligned relative to the first set of detection data along the time axis. In further implementations, the first set of detection data includes at least one peak corresponding to a compound present in the effluent and the second set of detection data includes at least one peak corresponding to the compound present in the effluent. In those further implementations, determining that the second set of detection data is misaligned relative to the first set of detection data includes determining that the at least one peak of the second set of detection data is misaligned relative to the at least one peak of the first set of detection data along the time axis.

Another aspect of the disclosure provides a computer-implemented method executed by data processing hardware that causes the data processing hardware to perform operations. The operations include receiving a first set of detection data. The first set of detection data is generated by a first detector of a gas chromatograph (GC) during a calibration session and includes a first set of peaks representative of chromatographic properties of a first portion of an effluent delivered to the first detector from a first transfer line of the GC during the calibration session. Each peak of the first set of peaks corresponds to one respective compound of a plurality of compounds present in the effluent. The operations include receiving a second set of detection data. The second set of detection data is generated by a second detector of the GC during the calibration session and includes a second set of peaks representative of chromatographic properties of a second portion of the effluent delivered to the second detector from a second transfer line of the GC during the calibration session. Each peak of the second set of peaks corresponds to one respective compound of the plurality of compounds present in the effluent. At least one peak of the second set of peaks is misaligned relative to a corresponding at least one peak of the first set of peaks along a time axis. The at least one peak of the second set of peaks and the corresponding at least one peak of the first set of peaks correspond to a same one respective compound of the plurality of compounds present in the effluent. The operations include receiving a temperature profile for the calibration session. The temperature profile identifies (i) a first temperature zone of the first portion of the effluent during the calibration session, and (ii) a second temperature zone of the second portion of the effluent during the calibration session. The operations include generating an alignment profile based on the temperature profile. The alignment profile, when applied to the second set of detection data, aligns the at least one peak of the second set of peaks and the corresponding at least one peak of the first set of peaks along the time axis.

Implementations of the disclosure may include one or more of the following features. In some examples, the first temperature zone includes a first temperature of the first portion of the effluent along the first transfer line. In those examples, the second temperature zone includes a second temperature of the second portion of the effluent along the second transfer line.

In some implementations, the operations further include receiving a flow condition profile of the GC. The flow condition profile identifies (i) a first set of flow conditions of the first portion of the effluent during the calibration session, and (ii) a second set of flow conditions of the second portion of the effluent during the calibration session. In those implementations, generating the alignment profile is further based on the flow condition profile. In further implementations, the first set of flow conditions includes (i) a length of the first transfer line, (ii) a diameter of the first transfer line, and (iii) an average flow velocity of the first portion of the effluent through the first transfer line during the calibration session. In those further implementations, the second set of flow conditions includes (i) a length of the second transfer line, (ii) a diameter of the second transfer line, and (iii) an average flow velocity of the second portion of the effluent through the second transfer line during the calibration session. In some further implementations, the first set of flow conditions and the second set of flow conditions are the same during the calibration session. Optionally, the first temperature zone and the second temperature zone are not the same during the calibration session.

In some examples, the plurality of compounds present in the effluent include a plurality of alkane compounds. In further examples, the plurality of alkane compounds includes even numbered n-alkanes between C₈ and C₄₀. In some implementations, the operations further include receiving a compound profile for the effluent. The compound profile identifies each compound of the plurality of compounds present in the effluent. In those implementations, generating the alignment profile is further based on the compound profile.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an analytical instrument assembly including a gas chromatography system having a single chromatographic column and a flow splitter.

FIG. 2 is a schematic view of an analytical instrument assembly including a gas chromatography system having a primary chromatographic column, a secondary chromatographic column, and a flow splitter.

FIG. 3 is a schematic view of an analytical instrument assembly including a gas chromatography system having a primary chromatographic column, a secondary chromatographic column, a three-tee flow modulator, and a three-tee flow splitter.

FIG. 4 is a schematic view of an alignment module that receives misaligned detection data generated by the gas chromatography system during a detection session and applies an alignment profile based on a temperature profile of the detection session to the misaligned detection data to align chromatographic peaks of the detection data along a time axis.

FIG. 5 is a schematic view of a calibration module that receives misaligned calibration data generated by the gas chromatography system during a calibration session and, based on a compound profile of a calibration effluent, determines the alignment profile for the gas chromatography system.

FIGS. 6 and 7 are schematic views of example outcomes of applying the alignment profile to misaligned detection data generated during respective detection sessions.

FIG. 8 is a flow chart of an example arrangement of operations for a method of aligning misaligned detection data using the alignment profile.

FIG. 9 is a flow chart of an example arrangement of operations for a method of generating the alignment profile during the calibration session.

Like reference symbols in the various drawings indicate like elements.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

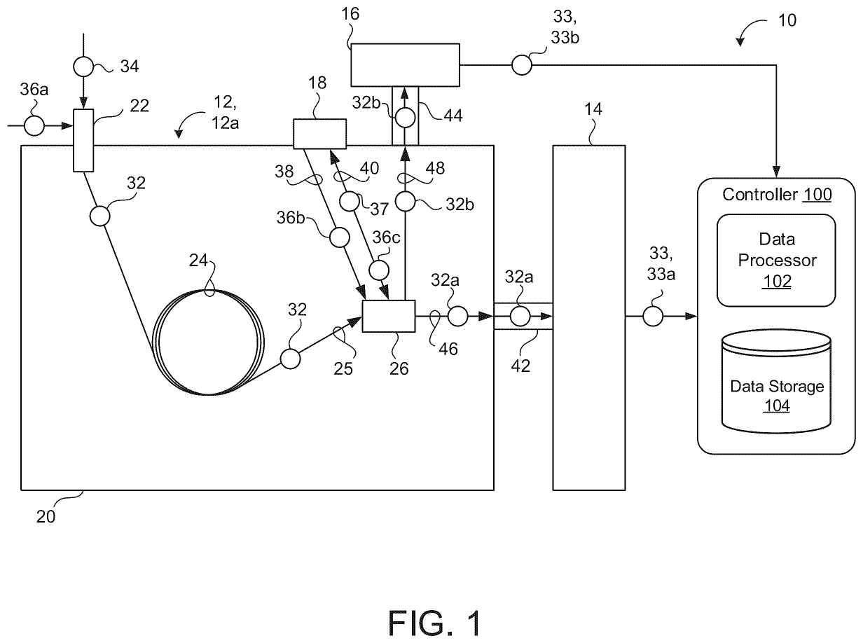

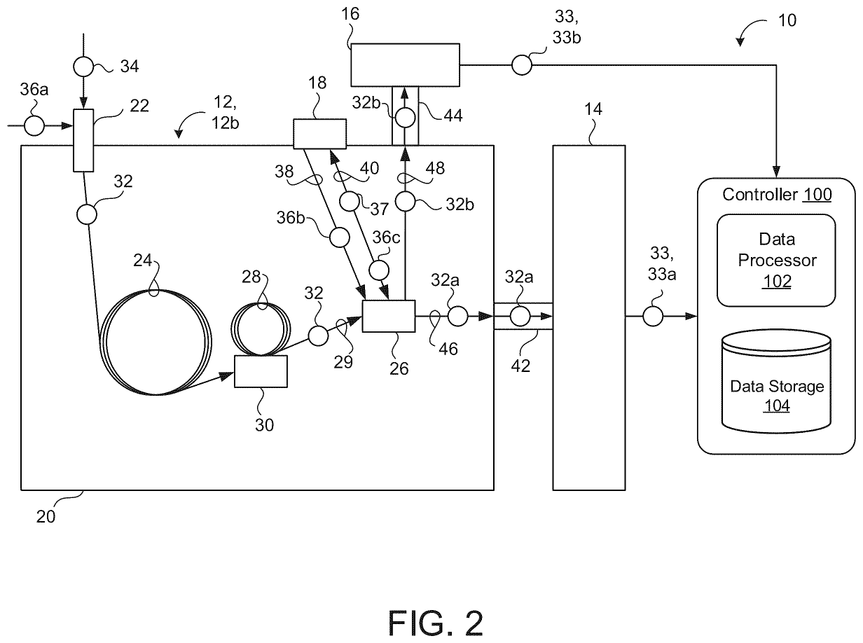

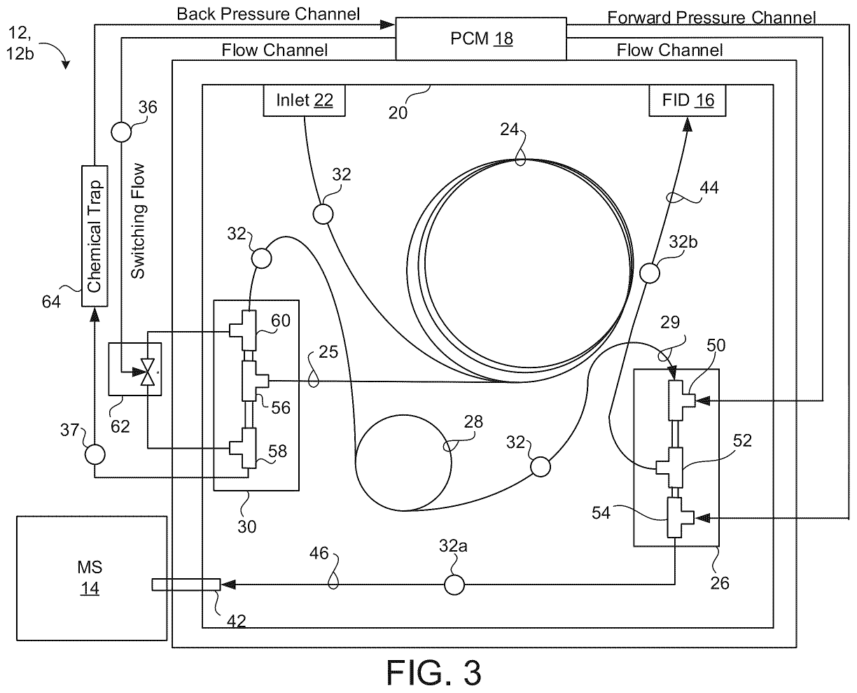

FIGS. 1-3 show implementations of an analytical instrument assembly 10. The assembly 10 may include a gas chromatography device 12, which may be a gas chromatograph (GC) 12, 12a, as shown in FIG. 1, or a comprehensive two-dimensional (multi-dimensional) gas chromatograph (GC×GC) 12, 12b, as shown in FIGS. 2 and 3. The analytical instrument assembly 10 may be interchangeably referred to as a “GC system 10” or simply “system 10”. As will become apparent, the principles of the present disclosure may apply to the GC 12a, the GC×GC 12b, and/or any other suitable gas chromatography device, including, but not limited to gas-liquid chromatography (GLC), gas-solid chromatography (GSC), etc. As discussed further below, the analytical device 10 and gas chromatographs 12 may utilize characteristics of the systems described in International Patent Application Ser. No. PCT-US2022-011989, filed Jan. 11, 2022 (Attorney Docket 223322-503198), which is hereby incorporated herein by reference in its entirety.

The assembly 10 may include a first detector 14 (e.g., a mass spectrometer (MS) 14) coupled to the gas chromatography device 12, a second detector 16 (e.g., a flame ionization detector (FID) 16) coupled to the gas chromatography device 12, and a pneumatic control module (PCM) 18. While the assembly 10 is described as including the MS 14 as the first detector and the FID 16 as the second detector, it should be understood that the first and second detectors 14, 16 may include any suitable detector(s), such as, a thermal conductivity detector (TCD), an alkali flame detector (AFD), a catalytic combustion detector (CCD), a discharge ionization detector (DID), a polyarc reactor, a flame photometric detector (FPD), an atomic emission detector (AED), an electron capture detector (ECD), a nitrogen-phosphorus detector (NPD), a dry electrolytic conductivity detector (DELCD), a vacuum ultraviolet (VUV), a Hall electrolytic conductivity detector (ElCD), a helium ionization detector (HID), an infrared detector (IRD), a photo-ionization detector (PID), a pulsed discharge ionization detector (PDD), a thermionic ionization detector (TID), etc. It should further be understood that any of the foregoing detectors may be arranged in any suitable combination.

With continued reference to FIGS. 1-3, the gas chromatography device 12 includes a main oven 20, an inlet 22, a primary column 24, and a flow splitter 26. With the exception of the GC×GC 12b including a secondary column 28 and a modulator 30, as shown in FIGS. 2 and 3 and as described in more detail below, the GC 12a and the GC×GC 12b, including the components and their functionality, may be substantially similar or the same. Accordingly, it should be understood that the description below applies to both the GC 12a and the GC×GC 12b, with the exception of the secondary column 28 and the modulator 30 applying to only the GC×GC 12b. When the analytical instrument assembly 10 includes the single dimensional GC 12a, the splitter 26 is coupled to an outlet end 25 of the primary column 24 and, when the analytical instrument assembly 10 includes the two-dimensional GC×GC 12b, the splitter is coupled to an outlet end 29 of the secondary column 28. Further, the analytical instrument assembly 10 may include a gas chromatography device having any suitable number of chromatographic columns with the flow splitter 26 coupled to an outlet end of a last chromatographic column.

The main oven 20 may house or receive at least the inlet 22, the primary column 24, the flow splitter 26, the secondary column 28, and the modulator 30. The inlet 22 may be configured to create an effluent 32 including a sample 34 (i.e., the eluite) and a first portion or stream of a carrier gas 36a (i.e., the eluent). The sample 34 may be injected into the inlet 22 via an injection device, such as, for example, a syringe, an automated injection device, or any other suitable means, and may be any suitable sample or analyte, such as, for example, petroleum, fragrances, drug-related liquids, etc. The first portion of the carrier gas 36a may be contained in a tank and may be any suitable gas, such as, for example, an inert gas such as helium, an unreactive gas such as nitrogen, etc. The first portion of the carrier gas 36a may be supplied to the inlet 22 in a constant stream and the sample 34 may be supplied to the inlet as an aliquot. The inlet 22 may mix the sample 34 and the first portion of the carrier gas 36a to form the effluent 32, and the inlet 22 may inject the effluent 32 into the primary column 24.

The primary column 24 and the secondary column 28 (and any additional column of a multi-dimensional gas chromatography device) may each be wound in a generally circular configuration or have any suitable configuration. For the GC 12a, the primary column 24 may extend from the inlet 22 to the outlet end 25 at the flow splitter 26. For the GC×GC 12b, the primary column 24 may extend from the inlet 22 to the modulator 30, and the secondary column 28 may extend from the modulator 30 to the outlet end 29 at the flow splitter 26. In some implementations, the primary column 24 and the secondary column 28 have different characteristics from each other. In one example, the primary column 24 may be longer, have a greater diameter, and/or contain a different stationary phase than the secondary column 28. In another example, the primary column 24 has a smaller diameter than the secondary column 28.

For the GC×GC 12b, the modulator 30 may be configured to receive the effluent 32 from the primary column 24 and perform modulation on the effluent 32 over a period of time referred to as a modulation period. The modulation process may include at least the steps of sampling the effluent 32 and injecting all or a portion of the effluent 32 into the secondary column 28. In some implementations, the modulation process includes an additional step of focusing the eluite 34 prior to injecting the eluite 34 into the secondary column 28. The modulation period is the time it takes for the modulator 30 to complete the modulation process, including the aforementioned steps.

From the outlet end 25 of the primary column 24 (for the GC 12a) or the outlet end 29 of the secondary column 28 (for the GC×GC 12b), the effluent 32 is received at the flow splitter 26. The PCM 18 may be coupled to the flow splitter 26 via a flow control capillary 38 and a makeup/exhaust flow capillary 40. The flow control capillary 38 is configured to deliver a second portion of the carrier gas 36b to the flow splitter 26 and the makeup/exhaust flow capillary 40 is configured to deliver a third portion (or makeup flow) of the carrier gas 36c to the flow splitter 26 or exhaust flow 37 from the flow splitter 26.

The flow splitter 26 divides or separates or portions the effluent 32 and provides a first flow or first portion 32a of the effluent 32 to the first detector 14 and provides a second flow or second portion 32b of the effluent 32 to the second detector 16. The first detector 14 may be coupled to the flow splitter 26 via a first transfer line 42 and the second detector 16 may be coupled to the flow splitter 26 via a second transfer line 44. Optionally, the first transfer line 42 and the second transfer line 44 include one or more restrictors between the flow splitter 26 and the respective detectors. The one or more restrictors define segments or portions of the transfer lines to provide varying lengths and inner diameters of the transfer lines. Thus, the first transfer line 42 and the second transfer line 44 may provide differing flow characteristics (e.g., average flow velocity) along the respective transfer lines. As shown, the first detector 14 is coupled to the flow splitter 26 via a first restrictor 46, such as a mass spectrometer (MS) restrictor 46, extending to or through the first transfer line 42. The second detector 16 may be coupled to the flow splitter 26 via a second restrictor 48, such as a flame ionization detector (FID) restrictor 48 extending to or through the second transfer line 44.

As shown in FIG. 3, the flow splitter 26 is a three-tee flow splitter 26 where a first tee 50 communicates with the outlet end 29 of the second column 28, the PCM 18, and a second tee 52 of the flow splitter 26. The second tee 52 communicates with the first tee 50, the second detector 16 (via the second transfer line 44), and a third tee 54 of the flow splitter 26. The third tee 54 communicates with the second tee 52, the PCM 18, and the first detector 14 (via the first transfer line 42 and restrictor 46). Thus, the three-tee flow splitter 26 receives the effluent 32 at the first tee 50, separates or divides the effluent 32, provides the first portion 32a of the effluent to the first detector 14 via the third tee 54, and provides the second portion 32b of the effluent to the second detector 16 via the second tee 52.

In the example shown, the modulator 30 includes a three-tee modulator 30 where a first tee 56 communicates with the outlet end 25 of the first column 24, a second tee 58, and a third tee 60 of the three-tee modulator 30. The third tee 60 also communicates with the second column 28 and the PCM 18. In some examples, the second tee 58 receives carrier gas 36 from the PCM 18 for mixing with the effluent 32 or to purge the effluent 32 toward the second column 28. The second tee 58 provides exhaust 37 flow to the PCM 18 and receives carrier gas 36 from the PCM 18. Thus, the three-tee modulator 30 receives the effluent 32 from the first column 24 at the first tee 56, provides the effluent 32 to the second column 28 via the third tee 60, provides exhaust 37 via the second tee 58, and receives carrier gas 36 from the PCM 18 via the third tee 60. The second tee 58 and third tee 60 may communicate with the PCM 18 through a three-way solenoid valve 62. In some implementations, the exhaust 37 provided by the second tee 58 is filtered through a chemical trap 64.

Thus, the analytical instrument assembly 10 includes the gas chromatograph 12a, 12b including at least the first chromatographic column 24 (and optionally the second chromatographic column 28), the flow splitter 26 receiving the effluent 32 from the outlet end 25 of the first column 24 (or the outlet end 29 of the second column 28) and providing the first portion 32a of the effluent 32 to the first detector 14 and the second portion 32b of the effluent to the second detector 16. The first transfer line 42 delivers the first portion 32a of the effluent 32 to the first detector 14 and the second transfer line 44 delivers the second portion 32b of the effluent to the second detector 16.

Referring to FIGS. 1, 2, and 4, the first detector 14 and the second detector 16 are configured to receive the respective first portion 32a or second portion 32b of the effluent 32, including the sample 34, and detect or collect or generate a plurality of raw data 33, 33a, 33b about the sample 34 within the first portion 32a and the second portion 32b, including, for example, retention time, signal (or intensity), etc. That is, during a detection session or detection program 400 the first detector 14 generates a first set of raw detection data 33a representative of chromatographic properties of the first portion 32a and the second detector 16 generates a second set of raw detection data 33b representative of chromatographic properties of the second portion 32b. Although described herein as being representative of retention time of the effluent 32, it should be understood that the detection data 33 may be representative of any suitable chromatographic property of the effluent 32. The detection session 400 represents a period time where the effluent 32 passes through the gas chromatograph 12 and detection data 33 is collected regarding the effluent 32. As described further below, the effluent 32 may alternatively pass through the gas chromatograph 12 during a calibration session 500.

The first detector 14 and the second detector 16 communicate (such as via wireless or wired communication) the raw data 33 to a computing device or controller 100. The computing device 100 may be any suitable device, such as, for example, a computer, a laptop, a tablet, a smartphone, etc. The computing device 100 may be used to program or control any suitable components of the assembly 10, including the PCM 18, the modulator 30, or the like. As shown, the controller 100 includes data processing hardware 102 (such as a data processor) and memory hardware 104 in communication with the data processing hardware 102. The memory hardware 104 may store instructions that are executed on the data processing hardware 102. Additionally, the memory hardware 104 stores the raw data 33 received at the computing device 100 and, as discussed further below, aligned data and/or chromatograms generated by the data processing hardware 102. The controller 100 may receive, analyze, and/or process the raw data 33 on an ongoing basis during the session or the controller 100 may receive the raw data 33 after the session has concluded. For example, the controller 100 receives raw data 33 from memory 104 and representative of a historical session at a previous point in time.

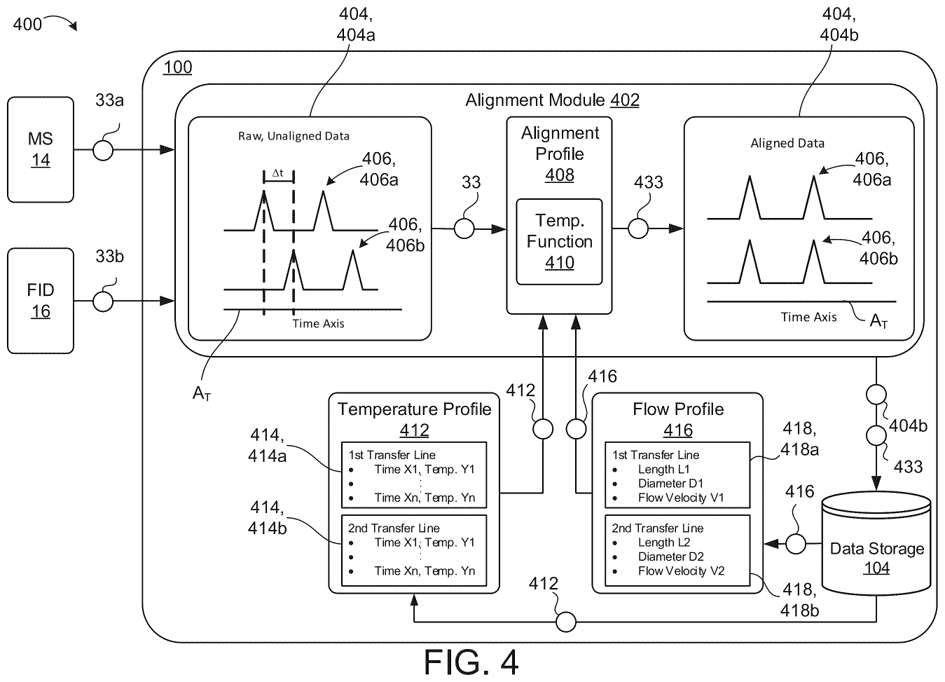

Referring to FIG. 4, the first set of raw detection data 33a and the second set of raw detection data 33b captured during a detection session 400 may be represented by a chromatogram 404, 404a, generated by the data processing hardware 100. For example, the chromatogram 404 may visually represent peak retention times of the effluent where the Y axis shows detection signals (i.e., peaks 406) measured by the first detector 14 and second detector 16 along a time axis A_{T} during the detection program 400. However, in the chromatogram 404 generated based on the raw detection data 33 (i.e., the raw data chromatogram 404a), the peaks 406 are misaligned along the time axis A_{T}. That is one or more first peaks 406, 406a representative of the chromatographic properties of the first portion 32a of the effluent 32 detected by the first detector 14 are misaligned relative to one or more second peaks 406, 406b representative of the chromatographic properties of the second portion 32b of the effluent 32 detected by the second detector 16.

Because the detection data 33 is representative of different portions of the effluent 32 eluting from the gas chromatograph 12 into the flow splitter 26 at the same time during the detection session 400, the misalignment of the peaks 406 is due to differences in travel times of the first portion 32a of the effluent 32 through the first transfer line 42 and the second portion 32b of the effluent 32 through the second transfer line 44. That is, peak retention times (i.e., the peaks 406) of a single gas chromatographic flow (i.e., the effluent 32) split to two or more detectors 14, 16 are not the same for the captured raw data 33a, 33b because the void times of the respective transfer lines 42, 44 are different. Thus, the peaks 406 corresponding to the raw detection data 33a captured by the first detector 14 are shifted along the time axis A_{T} by a time difference Δt as compared to the peaks 406 corresponding to the raw detection data 33b captured by the second detector 16. To link corresponding chromatographic peaks 406 detected at the detectors 14, 16, the retention times (i.e., the position of the peak 406 along the time axis A_{T}) must be aligned.

Void times of the effluent 32 along the first transfer line 42 and the second transfer line 44 may be calculated based on, for example, dimensions of the transfer lines 42, 44 (e.g., length, inner diameter, number and configuration of restrictors, and the like), the inlet and outlet pressures at the transfer lines 42, 44, and temperatures applied to the effluent 32 along the transfer lines 42, 44. However, these calculations are inaccurate and impractical due to the number and imprecision of inputs required. Thus, and as discussed further below, the controller 100, such as via an alignment module 402 operating on the data processing hardware 102, applies an alignment profile 408 to one or both sets of raw detection data 33a, 33b (e.g., the second set of raw detection data 33b) to align the detection data and transform the raw detection data 33 into aligned detection data 433. Optionally, the controller 100 first determines that the first set of raw detection data 33a and the second set of raw detection data 33b are misaligned along the time axis A_{T} and, responsive to determining the misalignment, applies the alignment profile 408. The aligned detection data 433 may be used to generate an aligned data chromatogram 404, 404b where the peaks 406 are aligned along the time axis A_{T}. Thus, the aligned data chromatogram 404b may provide a visual representation of the chromatographic properties of the effluent 32 that is easier to compare and interpret than the raw data chromatogram 404a. The aligned detection data 433 and/or the aligned data chromatogram 404a may be communicated to the user or stored in data storage 104 for subsequent retrieval by the data processing hardware 102 or display to the user.

A calibration session 500 generates the alignment profile 408 for applying to the sets of raw detection data 33 captured during any detection session 400 having the same configuration of the first transfer line 42 and the second transfer line 44, the same temperatures applied to the transfer lines 42, 44, and the same pressures of the effluent 32 from the splitter 26 to the transfer lines 42, 44 as the calibration session 500. That is, because the splitter 26 is configured to regulate or control flows of the first portion 32a and the second portion 32b of the effluent to the respective first detector 14 and the second detector 16 during the detection session 400, the alignment module 402 applies the same alignment profile 408 to the sets of raw detection data 33 generated during separate detection sessions having different chromatographic conditions, such as different column dimensions, different column flows, and different temperature programs, and the same conditions along the transfer lines 42, 44. In other words, with fixed restrictors 46, 48 and the same restrictor flow conditions of the first portion 32a and second portion 32b of the effluent 32 from the flow splitter 26, the alignment profile 408 is applied to detection data 33 captured under a range of chromatographic conditions.

While the flow splitter 26 standardizes flow conditions of the first portion 32a and second portion 32b of the effluent 32 to the first detector 14 and the second detector 16, the alignment profile 408 includes a temperature function 410 to adjust the raw detection data 33 based on a temperature profile 412 corresponding to the detection session 400. That is, the alignment profile 408 is based on the flow conditions provided by the splitter 26, the first transfer line 42, and the second transfer line 44 and aligns the raw detection data 33 according to the temperature function 410 and a temperature profile 412 of the detection session 400. In other words, the alignment profile 408 includes a temperature function 410 where the retention time difference between the first set of raw detection data 33a and the second set of raw detection data 33b is a function of temperature of the effluent 32 along the transfer lines 42, 44 during the detection session 400. Because the temperature profile 412 corresponding to a detection session 400 is not constant, and not necessarily linear, the time difference Δt between peaks 406 may not be constant and thus alignment requires conversion using the calibrated alignment profile 408 corresponding to the splitter 26 and flow conditions from the splitter 26. During a given detection session 400, the temperature experienced by the effluent 32 along the first transfer line 42 and second transfer line 44 may change over time and change along the length of the transfer lines 42, 44, therefore affecting the retention time of the peaks 406 detected by the first detector 14 and second detector 16.

To best represent temperatures of the effluent 32 during the detection session 400, the temperature profile 412 identifies temperatures present at the gas chromatograph 12a, 12b during the detection session 400 and representative of temperature zones 414, 414a, 414b experienced by the first portion 32a of the effluent 32 (i.e., a first temperature zone 414a) and by the second portion 32b of the effluent 32 (i.e., a second temperature zone 414b). For example, the temperature zones 414 include respective temperatures of the first transfer line 42 and the second transfer line 44 during the detection session 400 or temperatures of the first portion 32a and second portion 32b of the effluent 32 while travelling along the respective first transfer line 42 and second transfer line 44.

Because the temperature of the effluent 32 and portions of the gas chromatograph 12 vary over the course of the detection session 400, the temperature zones 414 define temperatures at multiple portions of the gas chromatograph 12a, 12b over time during the detection session 400. For example, respective portions of the first transfer line 42 and the second transfer line 44 are disposed in the oven 20 and thus are exposed to the variable temperature program applied to the gas chromatograph 12 during the detection session 400. Meanwhile, other portions of the first transfer line 42 and the second transfer line 44 are disposed exterior the oven, such as within the first detector 14 and the second detector 16, and thus are exposed to the temperatures present at the detectors. Thus, the temperature profile 412 may include respective temperature zones for the effluent 32 along the primary column 24, secondary column 28, first restrictor 46, second restrictor 48, first detector 14, second detector 16, oven 20, different segments of the first and second transfer lines 42, 44, and the like. The temperature zones 414 may be detected and tracked during the detection session 400, such as by one or more temperature sensors at the gas chromatograph 12a, 12b. Optionally, the temperature profile 412 is derived from a program applied to the gas chromatograph 12a, 12b during the detection session 400 and retrieved from memory 104. Thus, if the first temperature zone 414a and the second temperature zone 414b are not the same during the detection session 400, the alignment profile 408 adjusts or transforms the detection data 33 accordingly to align the peaks 406 as the temperatures vary.

In some implementations, the alignment module 400 receives a flow condition profile 416 for the detection session 400 where the flow condition profile 416 identifies flow conditions of the first portion 32a and the second portion 32b of the effluent 32 from the flow splitter 26 to the first detector 14 and the second detector 16. Thus, if the conditions of the first transfer line 42 and the second transfer line 44 vary between detection sessions 400, such as if the splitter 26 is connected to different transfer lines, the alignment profile 408 is updated accordingly. For example, the alignment profile 408 is updated to reflect an alignment profile 408 generated during a calibration session 500 corresponding to the temperature profile 412 and flow profile 416 for the detection session 400. Here, the flow condition profile 416 includes a first set of flow conditions 418, 418a corresponding to the first portion 32a of the effluent 32 along the first transfer line 42 and a second set of flow conditions 418, 418b corresponding to the second portion 32b of the effluent 32 along the second transfer line 44 during the detection session 400. The first set of flow conditions 418a and the second set of flow conditions 418b each include the length, the diameter, and the average flow velocity of the respective first portion 32a or second portion 32b of the effluent 32 through the respective first transfer line 42 or second transfer line 44. The first set of flow conditions and the second set of flow conditions may be detected via sensor during the detection session 400 or derived from a program applied to the gas chromatograph 12a, 12b during the detection session 400 and retrieved from memory 104.

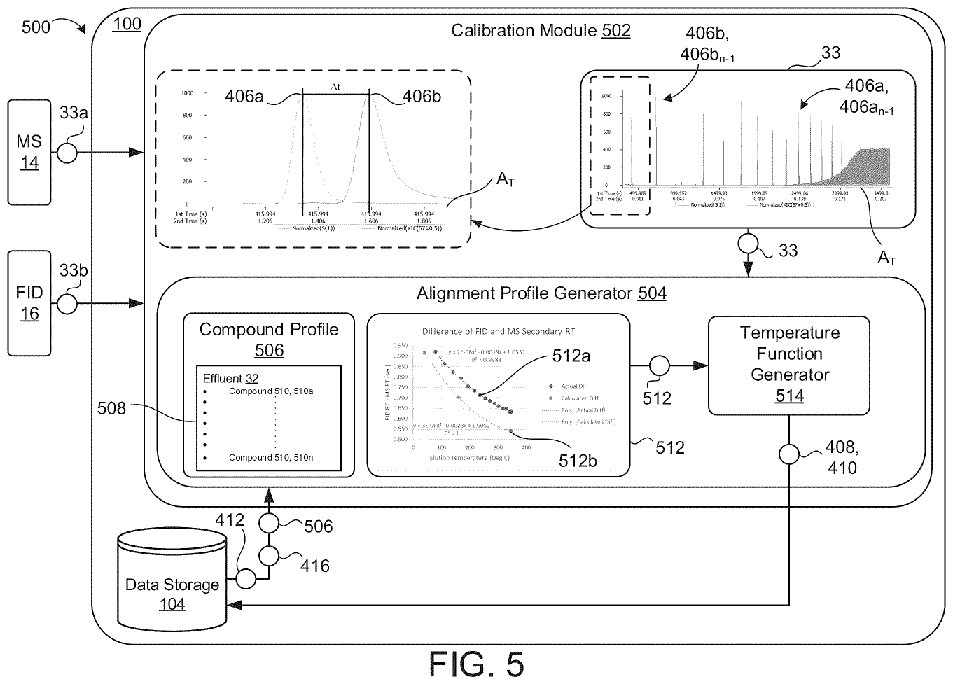

Referring to FIG. 5, the alignment profile 408 and the temperature function 410 are generated during a calibration session 500. The calibration session 500 employs the gas chromatograph 12 in a similar fashion as a detection session 400, except that the effluent 32 contains a set of known reference compounds 508 with elution temperatures (i.e., peaks 406) that span the temperature range of operation. The set of reference compounds 508 are chromatographed at typical conditions (e.g., with fixed flow conditions for the splitter 26) and the elution temperature of each compound of the set of reference compounds 508 is determined based on retention times and the temperature profile 412 of the calibration session 500. Here, the reference compounds 508 present in the effluent 32 include even numbered n-alkanes from C₈ to C₄₀. Thus, the alignment profile 408 and temperature function 410 are generated during the calibration session 500 and may be used to align detection data 33 generated during a detection session 400 having a temperature profile 412 that is different or the same as the calibration session 500.

As shown, a calibration module 502 operating on the controller 100 receives the first set of detection data 33a and the second set of detection data 33b representative respectively of the first portion 32a of the effluent 32 and the second portion 32b of the effluent 32 during the calibration session 500. The first set of detection data 33a includes a first set of peaks 406a, 406a₁₋ₙ where each first peak 406a corresponds to a compound 510 of the set of reference compounds 508. Similarly, the second set of detection data 33b includes a second set of peaks 406b, 406b₁₋ₙ where each second peak 406b corresponds to a compound 510 of the set of reference compounds 508. The peaks 406 of the first set of peaks 406a and the peaks 406 of the second set of peaks 406b should match or correspond to the same compounds when aligned along the time axis A_{T}. However, when initially received as raw detection data 33, at least one peak 406 of the first set of peaks 406a and at least one corresponding peak 406 of the second set of peaks 406b does not align along the time axis A_{T} when the void times of the first transfer line 42 and second transfer line 44 are different. The time differences Δt between detection signals for is different compounds 510 present in the first portion 32a and second portion 32b of the effluent 32 may not be the same because the temperature profile 414 identifies non-constant or non-uniform or non-linear temperatures along the first transfer line 42 and second transfer line 44 during the calibration session 500.

An alignment profile generator 504 receives the misaligned raw detection data 33, a temperature profile 412 corresponding to the calibration session 500, and a compound profile 506 of the effluent 32. The compound profile 506 identifies each compound 510, 510a-n present in the set of reference compounds 508 of the effluent 32 during the calibration session 500. Based on the temperature profile 412 and the compound profile 506, the alignment profile generator 504 generates the alignment profile 408 and temperature function 410 so that, when applied to the raw detection data 33, the alignment profile 408 aligns the peaks 406a of the first set of detection data 33a and the peaks 406b of the second set of detection data 33b. The compound profile 506 may be input by a user or retrieved from memory 104 based on, for example, a defined calibration protocol stored in memory 104. Optionally, the alignment profile 408 may be generated without use of the compound profile 506, such as if the misalignment of corresponding peaks is minimal and thus peaks corresponding to the same compound 510 can be assumed to be adjacent (or otherwise knowingly spaced) relative to one another. In some implementations, the alignment profile generator 504 generates the alignment profile 408 based on a received flow profile 416 corresponding to the calibration session 500 to further improve accuracy of the temperature function 410.

As shown, the alignment profile generator 504 uses the temperature profile 412 and the compound profile 506 to determine the elution temperature for each compound 510 and determine the time difference Δt between detection signals (i.e., peaks 406) for each compound 510. The time differences Δt are plotted against the elution temperatures for each compound 510 to generate a time differential plot 512. The temperature function 410 is determined based on the time differential plot 512. For example, the time differential plot 512 is processed by a temperature function generator 514 to determine the temperature function 410, such as by applying a line of best fit to the time differential plot 512. The alignment profile 408 and temperature function 410 are then stored in memory 104 for subsequent use during detection sessions 400. Thus, the temperature function 410 may be used to determine a time difference Δt between peaks 406a, 406b of an unknown compound to align the peaks 406a, 406b along the time axis A_{T}.

To illustrate the importance of performing the calibration session 500, the time differential plot 512 shown in FIG. 5 includes a first plot 512a calculated based on the nominal dimensions of the first transfer line 42 and the second transfer line 44 (e.g., length and inner diameter of the transfer lines) and a second plot 512b generated based on the time differences Δt determined during the calibration session 500. As shown, the first plot 512a and the second plot 512b share the same general shape, but are offset considerably. Thus, the calibration session 500 improves the alignment significantly over the nominal calculations.

An example method of transforming misaligned detection data 33 generated during a detection session 400 to aligned data 433 will be described herein. First, the time values corresponding to respective peaks 406 are matched to corresponding temperature values based on the temperature profile 412 of the detection session 400. That is, the time value of a respective peak 406 is matched to a temperature of the effluent at that time during the detection session 400. Based on the temperature profile 412 and the flow condition profile 416, the alignment module 402 determines time difference Δt values for the first set 33a and the second set 33b of detection data 33. For example, time difference Δt values are determined for only the second set 33b of detection data 33 to shift the second set 33b relative to the first set 33a and the time difference values Δt values are unique to respective peaks 406a, 406b of the detection data 33. The alignment module 402 applies the alignment profile 408 based on the temperature function 410 to generate aligned detection data 433.

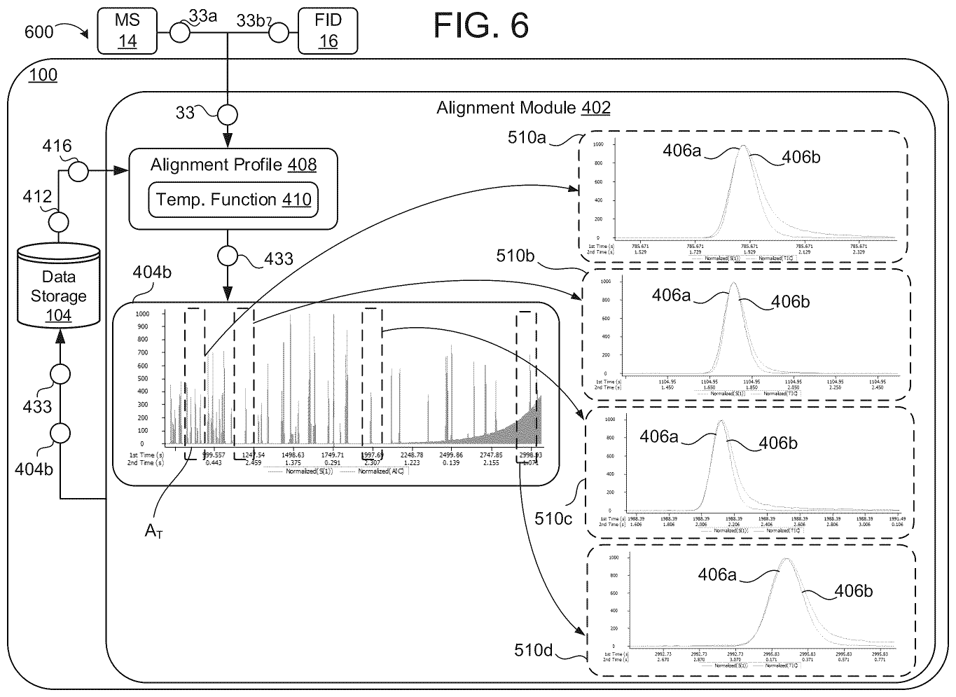

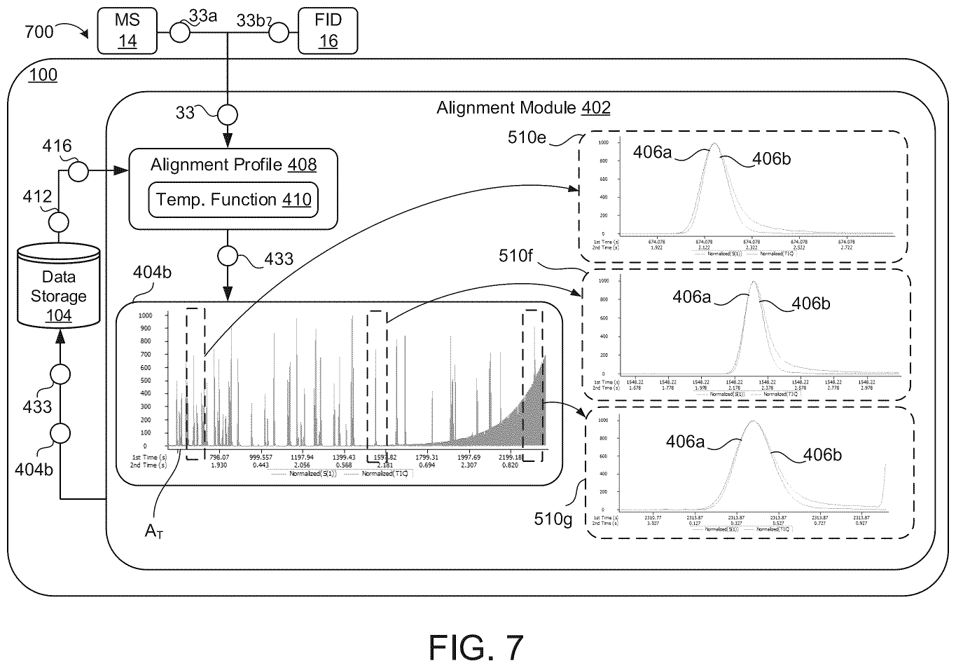

FIGS. 6 and 7 depict example detection sessions 600, 700 where the alignment profile 408 has been applied to misaligned raw detection data 33 to generate aligned detection data 433 where respective peaks 406a, 406b representative of the first portion 32a of the effluent 32 and the second portion 32b of the effluent 32 have been aligned along the time axis A_{T}. As shown in FIG. 6, the aligned chromatogram 404b includes aligned peaks 406a, 406b corresponding to an early eluting compound 510a having a first elution temperature, a first intermediary eluting compound 510b having a second elution temperature higher than the first elution temperature, a second intermediary compound 510c having a third elution temperature higher than the second elution temperature, and a late eluting compound 510d having a fourth elution temperature higher than the third elution temperature. The misaligned detection data 33 resulting in the aligned chromatogram 404b of FIG. 6 was collected at different chromatographic flows (such as 0.5/30 mL/min primary and secondary column flows) than those used during the calibration session 500, and at the same heating rate (i.e., the same temperature profile 412) (such as 6 degrees Celsius per minute) as that used during the calibration session 500. The aligned data 433 and the aligned data chromatogram 404b generated by the alignment module 402 are stored in memory 104.

Similarly, as shown in FIG. 7, the aligned chromatogram 404b includes aligned peaks 406a, 406b corresponding to another early eluting compound 510e having a fifth elution temperature, another intermediary eluting compound 510f having a sixth elution temperature higher than the fifth elution temperature, and another late eluting compound 510g having a seventh elution temperature higher than the sixth elution temperature. The misaligned detection data 33 resulting in the aligned chromatogram 404b of FIG. 7 was collected at the same flow profile 416 as those used during the calibration session 500, and at a different heating rate (i.e., a different temperature profile 412) (such as 8 degrees Celsius per minute) than that used during the calibration session 500 (such as 6 degrees Celsius per minute). The aligned data 433 and the aligned data chromatogram 404b generated by the alignment module 402 are stored in memory 104.

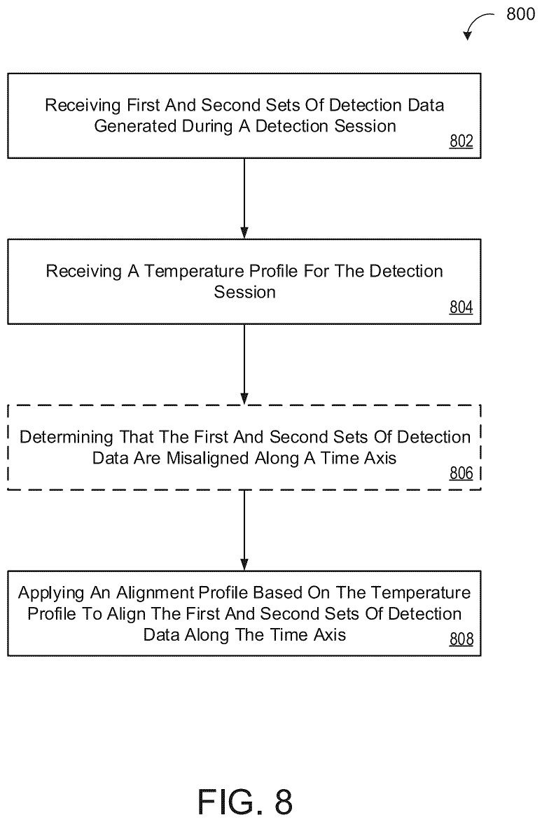

FIG. 8 is a flow chart of an example arrangement of operations for a method 800 of aligning misaligned chromatograph data. The data processing hardware 102 of the controller 100 may execute instructions stored on the memory hardware 104 of the controller 100 that causes the data processing hardware 102 to perform the operations. Δt operation 802, the method 800 includes receiving a first set of raw detection data 33a generated by a first detector 14 of a gas chromatograph 12a, 12b during a detection session 400 and representative of chromatographic properties of a first portion 32a of an effluent 32 delivered to the first detector 14 from a first transfer line 42 during the detection session 400. Operation 802 further includes receiving a second set of raw detection data 33b generated by a second detector 16 of the gas chromatograph 12a, 12b during the detection session 400 and representative of chromatographic properties of a second portion 32b of the effluent 32 delivered to the second detector 16 from a second transfer line 44 during the detection session 400. Δt operation 804, the method 800 includes receiving a temperature profile 412 for the detection session 400. The temperature profile 412 identifies a first temperature zone 414a of the first portion 32a of the effluent 32 during the detection session 400 and a second temperature zone 414b of the second portion 32b during the detection session 400. Optionally at operation 806, the method 800 includes determining that the second set of detection data 33b is misaligned relative to the first set of detection data 33a along a time axis A_{T}. The method 800 includes, at operation 808, applying an alignment profile 408 to the second set of detection data 33b to align the first set of detection data 33a and the second set of detection data 33b along the time axis A_{T}, the alignment profile 408 based on the temperature profile 412 for the detection session 400.

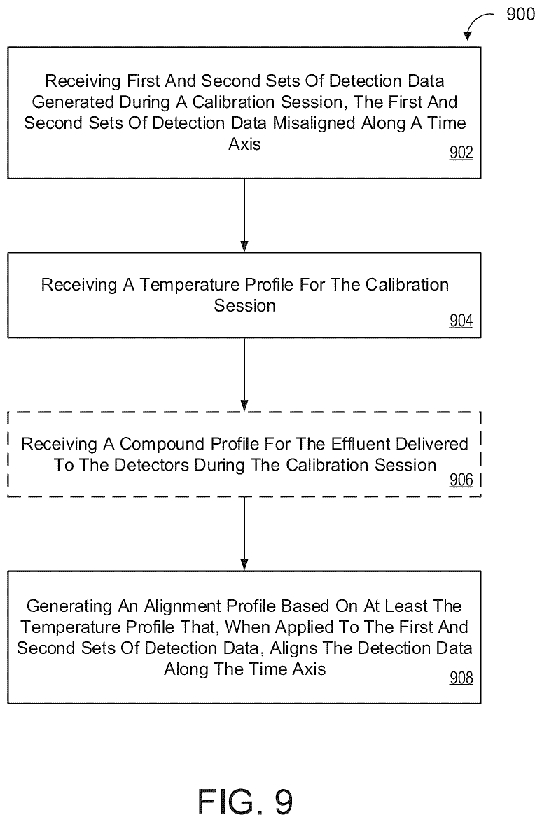

FIG. 9 is a flow chart of an example arrangement of operations for a method 900 of generating an alignment profile for aligning misaligned chromatograph data during a calibration session 500. The data processing hardware 102 of the controller 100 may execute instructions stored on the memory hardware 104 of the controller 100 that causes the data processing hardware 102 to perform the operations. Δt operation 902, the method 900 includes receiving a first set of detection data 33a. The first set of detection data 33a is generated by a first detector 14 of a gas chromatograph 12a, 12b during a calibration session 500 and includes a first set 406aₙ₋₁ of peaks 406 representative of chromatographic properties of a first portion 32a of an effluent 32 delivered to the first detector 14 from a first transfer line 42 of the gas chromatograph 12a, 12b during the calibration session 500. Each peak 406 of the first set of peaks 406a corresponds to one respective compound 510 of a plurality of compounds present in the effluent 32. Operation 902 further includes receiving a second set of detection data 33b. The second set of detection data 33b is generated by a second detector 16 of the gas chromatograph 12a, 12b during the calibration session 500 and includes a second set 406bₙ₋₁ of peaks 406 representative of chromatographic properties of a second portion 32b of the effluent 32 delivered to the second detector 16 from a second transfer line 44 of the gas chromatograph 12a, 12b during the calibration session 500. Each peak 406 of the second set of peaks 406b corresponds to one respective compound 510 of a plurality of compounds present in the effluent 32. Δt least one peak 406 of the second set of peaks 406b is misaligned relative to a corresponding at least one peak 406 of the first set of peaks 406a along a time axis A_{T}. The at least one peak 406 of the second set of peaks 406b and the corresponding at least one peak 406 of the first set of peaks 406a corresponds to a same one respective compound 510 of the plurality of compounds present in the effluent 32. Δt operation 904, the method 900 includes receiving a temperature profile 412 for the calibration session 500. The temperature profile 412 identifies a first temperature zone 414a of the first portion 32a of the effluent 32 during the calibration session 500 and a second temperature zone 414b of the second portion 32b during the calibration session 500. Optionally at operation 906, the method 900 includes receiving a compound profile 506 for the effluent 32, where the compound profile 506 identifies each compound 510 of the plurality of compounds present in the effluent 32. Δt operation 908, the method 900 includes generating an alignment profile 408 based on the temperature profile 412, and optionally the compound profile 506. The alignment profile 408, when applied to the second set of detection data 33b, aligns the at least one peak 406 of the second set of peaks 406b and the corresponding at least one peak 406 of the first set of peaks 406a along the time axis A_{T}.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
receiving a first set of detection data, the first set of detection data generated by a first detector of a gas chromatograph (GC) during a detection session and representative of chromatographic properties of a first portion of an effluent delivered to the first detector from a first transfer line of the GC during the detection session;
receiving a second set of detection data misaligned relative to the first set of detection data along a time axis, the second set of detection data generated by a second detector of the GC during the detection session and representative of chromatographic properties of a second portion of the effluent delivered to the second detector from a second transfer line of the GC during the detection session;
receiving a temperature profile for the detection session, the temperature profile identifying:
a first temperature zone of the first portion of the effluent during the detection session; and
a second temperature zone of the second portion of the effluent during the detection session; and
applying an alignment profile to the second set of detection data to align the first set of detection data and the second set of detection data along the time axis, the alignment profile based on the temperature profile for the detection session.

2. The method of claim 1, wherein:
the first temperature zone comprises a first temperature of the first portion of the effluent along the first transfer line; and
the second temperature zone comprises a second temperature of the second portion of the effluent along the second transfer line.

3. The method of claim 1, wherein the alignment profile is further based on a flow condition profile identifying:
a first set of flow conditions of the first portion of the effluent during the detection session; and
a second set of flow conditions of the second portion of the effluent during the detection session.

4. The method of claim 3, wherein:
the first set of flow conditions comprises:
a length of the first transfer line;
a diameter of the first transfer line; and
an average flow velocity of the first portion of the effluent through the first transfer line during the detection session; and
the second set of flow conditions comprises:
a length of the second transfer line;
a diameter of the second transfer line; and
an average flow velocity of the second portion of the effluent through the second transfer line during the detection session.

5. The method of claim 3, wherein the first set of flow conditions and the second set of flow conditions are the same during the detection session.

6. The method of claim 1, wherein the first temperature zone and the second temperature zone are not the same during the detection session.

7. The method of claim 1, wherein:
the first transfer line receives the first portion of the effluent from a flow splitter of the GC;
the second transfer line receives the second portion of the effluent from the flow splitter; and
the flow splitter receives the effluent from an outlet end of a chromatographic column.

8. The method of claim 7, wherein:
the GC comprises a single-dimensional GC having a single chromatographic column; and
the flow splitter receives the effluent from the outlet end of the single chromatographic column.

9. The method of claim 7, wherein:
the GC comprises a multi-dimensional GC having a plurality of chromatographic columns; and
the flow splitter receives the effluent from the outlet end of a last chromatographic column of the plurality of chromatographic columns.

10. The method of claim 1, wherein the operations further comprise generating the alignment profile based on calibration data obtained by the first detector and the second detector during a calibration session, the calibration data representative of chromatographic properties of a calibration effluent different from the effluent of the detection session.

11. The method of claim 1, wherein:
the operations further comprise determining that the second set of detection data is misaligned relative to the first set of detection data along the time axis; and
applying the alignment profile is in response to determining that the second set of detection data is misaligned relative to the first set of detection data along the time axis.

12. The method of claim 11, wherein:
the first set of detection data comprises at least one peak corresponding to a compound present in the effluent;
the second set of detection data comprises at least one peak corresponding to the compound present in the effluent; and
determining that the second set of detection data is misaligned relative to the first set of detection data comprises determining that the at least one peak of the second set of detection data is misaligned relative to the at least one peak of the first set of detection data along the time axis.

13. A system comprising:
a gas chromatograph (GC) comprising:
a chromatographic column having an outlet end;
a first detector;
a second detector;
a first transfer line configured to deliver a first portion of an effluent to the first detector from the outlet end of the chromatographic column; and
a second transfer line configured to deliver a second portion of the effluent to the second detector from the outlet end of the chromatographic column; and
a controller performing operations comprising:
receiving a first set of detection data, the first set of detection data generated by the first detector during a detection session and representative of chromatographic properties of the first portion of the effluent;
receiving a second set of detection data misaligned relative to the first set of detection data along a time axis, the second set of detection data generated by the second detector during the detection session and representative of chromatographic properties of the second portion of the effluent;
receiving a temperature profile for the detection session, the temperature profile identifying:
a first temperature zone of the first portion of the effluent during the detection session; and
a second temperature zone of the second portion of the effluent during the detection session; and
applying an alignment profile to the second set of detection data to align the first set of detection data and the second set of detection data along the time axis, the alignment profile based on the temperature profile for the detection session.

14. The system of claim 13, wherein:
the first temperature zone comprises a first temperature of the first portion of the effluent along the first transfer line; and
the second temperature zone comprises a second temperature of the second portion of the effluent along the second transfer line.

15. The system of claim 13, wherein the alignment profile is further based on a flow condition profile identifying:
a first set of flow conditions of the first portion of the effluent during the detection session; and
a second set of flow conditions of the second portion of the effluent during the detection session.

16. The system of claim 15, wherein:
the first set of flow conditions comprises:
a length of the first transfer line;
a diameter of the first transfer line; and
an average flow velocity of the first portion of the effluent through the first transfer line during the detection session; and
the second set of flow conditions comprises:
a length of the second transfer line;
a diameter of the second transfer line; and
an average flow velocity of the second portion of the effluent through the second transfer line during the detection session.

17. The system of claim 15, wherein the first set of flow conditions and the second set of flow conditions are the same during the detection session.

18. The system of claim 13, wherein the first temperature zone and the second temperature zone are not the same during the detection session.

19. The system of claim 13, wherein:
the first transfer line receives the first portion of the effluent from a flow splitter of the GC;
the second transfer line receives the second portion of the effluent from the flow splitter; and
the flow splitter receives the effluent from the outlet end of the chromatographic column.

20. The system of claim 19, wherein:
the GC comprises a single-dimensional GC having a single chromatographic column; and
the flow splitter receives the effluent from the outlet end of the single chromatographic column.

21. The system of claim 19, wherein:
the GC comprises a multi-dimensional GC having a plurality of chromatographic columns; and
the flow splitter receives the effluent from the outlet end of a last chromatographic column of the plurality of chromatographic columns.

22. The system of claim 13, wherein the operations further comprise generating the alignment profile based on calibration data obtained by the first detector and the second detector during a calibration session, the calibration data representative of chromatographic properties of a calibration effluent different from the effluent of the detection session.

23. The system of claim 13, wherein:
the operations further comprise determining that the second set of detection data is misaligned relative to the first set of detection data along the time axis; and
applying the alignment profile is in response to determining that the second set of detection data is misaligned relative to the first set of detection data along the time axis.

24. The system of claim 23, wherein:
the first set of detection data comprises at least one peak corresponding to a compound present in the effluent;
the second set of detection data comprises at least one peak corresponding to the compound present in the effluent; and
determining that the second set of detection data is misaligned relative to the first set of detection data comprises determining that the at least one peak of the second set of detection data is misaligned relative to the at least one peak of the first set of detection data along the time axis.

25. A computer-implemented method executed by data processing hardware that causes the data processing hardware to perform operations comprising:
receiving a first set of detection data, the first set of detection data generated by a first detector of a gas chromatograph (GC) during a calibration session and comprising a first set of peaks representative of chromatographic properties of a first portion of an effluent delivered to the first detector from a first transfer line of the GC during the calibration session, wherein each peak of the first set of peaks corresponds to one respective compound of a plurality of compounds present in the effluent;
receiving a second set of detection data, the second set of detection data generated by a second detector of the GC during the calibration session and comprising a second set of peaks representative of chromatographic properties of a second portion of the effluent delivered to the second detector from a second transfer line of the GC during the calibration session, wherein:
each peak of the second set of peaks corresponds to one respective compound of the plurality of compounds present in the effluent; and
at least one peak of the second set of peaks is misaligned relative to a corresponding at least one peak of the first set of peaks along a time axis, the at least one peak of the second set of peaks and the corresponding at least one peak of the first set of peaks corresponding to a same one respective compound of the plurality of compounds present in the effluent;
receiving a temperature profile for the calibration session, the temperature profile identifying:
a first temperature zone of the first portion of the effluent during the calibration session; and
a second temperature zone of the second portion of the effluent during the calibration session; and
generating an alignment profile based on the temperature profile, the alignment profile, when applied to the second set of detection data, aligns the at least one peak of the second set of peaks and the corresponding at least one peak of the first set of peaks along the time axis.

26. The method of claim 25, wherein:
the first temperature zone comprises a first temperature of the first portion of the effluent along the first transfer line; and
the second temperature zone comprises a second temperature of the second portion of the effluent along the second transfer line.

27. The method of claim 25, wherein:
the operations further comprise receiving a flow condition profile of the GC, the flow condition profile identifying:
a first set of flow conditions of the first portion of the effluent during the calibration session; and
a second set of flow conditions of the second portion of the effluent during the calibration session; and
generating the alignment profile is further based on the flow condition profile.

28. The method of claim 27, wherein:
the first set of flow conditions comprises:
a length of the first transfer line;
a diameter of the first transfer line; and
an average flow velocity of the first portion of the effluent through the first transfer line during the calibration session; and
the second set of flow conditions comprises:
a length of the second transfer line;
a diameter of the second transfer line; and
an average flow velocity of the second portion of the effluent through the second transfer line during the calibration session.

29. The method of claim 27, wherein the first set of flow conditions and the second set of flow conditions are the same during the calibration session.

30. The method of claim 25, wherein the first temperature zone and the second temperature zone are not the same during the calibration session.

31. The method of claim 25, wherein the plurality of compounds present in the effluent comprise a plurality of alkane compounds.

32. The method of claim 31, wherein the plurality of alkane compounds comprises even numbered n-alkanes between C₈ and C₄₀ n-alkanes.

33. The method of claim 25, wherein:
the operations further comprise receiving a compound profile for the effluent, the compound profile identifying each compound of the plurality of compounds present in the effluent; and
generating the alignment profile is further based on the compound profile.
